(19) United States
(12) Patent Application Publication
(10) Pub. No.: US 2015/0010083 A1
(43) Pub. Date: Jan. 8, 2015

(54) VIDEO DECODING METHOD AND APPARATUS USING THE SAME

(71) Applicant: Electronics and Telecommunications Research Institute, Daejeon (KR)

(72) Inventors: Ha Hyun LEE, Seoul (KR); Jung Won KANG, Daejeon (KR); Jin Ho LEE, Daejeon (KR); Jin Soo CHOI, Daejeon (KR); Jin Woong KIM, Daejeon (KR)

(21) Appl. No.: 14/324,974

(22) Filed: Jul. 7, 2014

(30) Foreign Application Priority Data
Jul. 8, 2013 (KR) 10-2013-0079804
Jul. 29, 2013 (KR) 10-2013-0089259
May 30, 2014 (KR) 10-2014-0066011

(51) Int. Cl. H04N 19/583; H04N 19/196; H04N 19/82; H04N 19/51

(52) U.S. Cl. CPC H04N 19/00733; H04N 19/00684; H04N 19/00369; H04N 19/00896
USPC 375/240.16; 375/240.12

(57) ABSTRACT

A video decoding method according to an embodiment of the present invention may include decoding information on a first-layer picture to which a second-layer picture as a decoding target refers; generating information on a base inter-layer reference picture using the information on the first-layer picture; generating information on an enhanced inter-layer reference picture using the information on the first-layer picture, the information on the base inter-layer reference picture and information on the second-layer picture; and generating a reference picture list used for inter prediction of the second-layer picture using the information on the base inter-layer reference picture, the information on the enhanced inter-layer reference picture and the information on the second-layer picture.

### CROSS-REFERENCE TO RELATED APPLICATION

This application claims the benefit of priority of Korean Patent Applications No. 10-2013-0079804 filed on Jul. 8, 2013, No. 10-2013-0089259 filed on Jul. 29, 2013 and No. 10-2014-0066011 filed on May 30, 2014 which are incorporated by reference in its entirety herein.

### TECHNICAL FIELD

The present invention relates to video encoding and decoding, and more particularly, to a method and apparatus for encoding and decoding a video supporting a plurality of layers in a bit stream.

### BACKGROUND ART

In recent years, as high definition (HD) broadcast services are spreading domestically and globally, a large number of users are getting used to high-resolution and high-quality videos and accordingly institutions put spurs to the development of next-generation video devices. Also, with growing interest in ultrahigh-definition (UHD) services having a resolution four times higher than HDTV, compression techniques for higher-quality videos are needed.

For video compression, there may be used an inter prediction technique of predicting pixel values included in a current picture from temporally previous and/or subsequent pictures of the current picture, an intra prediction technique of predicting pixel values included in a current picture using pixel information in the current picture, or an entropy encoding technique of assigning a short code to a symbol with a high appearance frequency and assigning a long code to a symbol with a low appearance frequency.

Video compression technology may include a technique of providing a constant network bandwidth in restricted operating environments of hardware without considering variable network environments. However, to compress video data used for network environments involving frequent changes of bandwidths, new compression techniques are required, wherein a scalable video encoding/decoding method may be employed.

### DISCLOSURE

### Technical Problem

An aspect of the present invention is to provide a video decoding method capable of reducing complexity of an encoder and a decoder by performing integer pixel-based motion compensation in generating an enhanced inter-layer reference picture, and an apparatus using the same.

Another aspect of the present invention is to provide a video decoding method capable of enhancing decoding efficiency by applying a weighting based on an encoding parameter and thus omitting transmission of weighting information, and an apparatus using the same.

Still another aspect of the present invention is to provide a video decoding method capable of enhancing precision of lower-layer information available as a prediction signal in encoding and decoding a video in an upper layer when encoding and decoding a video based on a multi-layer structure, and an apparatus using the same.

### Technical Solution

An embodiment of the present invention provides a video decoding method supporting a plurality of layers, the video decoding method including decoding information on a first-layer picture to which a second-layer picture which is a target decoding layer refers; generating information on a base inter-layer reference picture using the information on the first-layer picture; generating information on an enhanced inter-layer reference picture using the information on the first-layer picture, the information on the base inter-layer reference picture and information on the second-layer picture; and generating a reference picture list used for inter prediction of the second-layer picture using the information on the base inter-layer reference picture, the information on the enhanced inter-layer reference picture and the information on the second-layer picture.

The generating of the information on the base inter-layer reference picture may include generating a first base inter-layer reference picture by mapping a size of the first-layer picture to a size of the second-layer picture; and generating a second base inter-layer reference picture by mapping a size of decoded temporal reference pictures of the first-layer picture to a size of a temporal reference picture of the second-layer picture.

The generating of the information on the enhanced inter-layer reference picture may include deriving a first reference block subjected to motion compensation with respect to a target block using a reference picture of the second-layer picture and a motion vector of a block of the first-layer picture corresponding to the target block as a decoding target of the second-layer picture; deriving a second reference block subjected to motion compensation with respect to an inter-layer corresponding block of the first base inter-layer reference picture corresponding to the target block using the second base inter-layer reference picture and the motion vector; generating a differential block corresponding to a difference between the first reference block and the second reference block; and adding the differential block with the inter-layer corresponding block.

The video decoding method may further include applying a weighting to the differential block.

The video decoding method may further include determining whether a reference picture index of a temporal reference picture of the first-layer picture has a preset value, wherein if the reference picture index has the preset value, motion compensation may be performed with respect to the target block and the inter-layer corresponding block using a motion interpolation filter.

Motion compensation for deriving the first reference block and the second reference block may be performed by an integer-pixel unit.

The generating of the information on the enhanced inter-layer reference picture may include generating a differential picture between a reference picture of the second-layer picture and the second base inter-layer reference picture; deriving a third reference block subjected to motion compensation with respect to an inter-layer corresponding block of the first base inter-layer reference picture corresponding to a target block using the differential picture and a motion vector of a block of the first-layer picture corresponding to the target block as a decoding target of the second-layer picture; and adding the third reference block and the inter-layer corresponding block.

The video decoding method may further include applying a weighting to the third reference block.

The video decoding method may further include determining whether a reference picture index of a temporal reference picture of the first-layer picture has a preset value, wherein if the reference picture index has the preset value, motion compensation may be performed with respect to the target block and the inter-layer corresponding block using a motion interpolation filter.

Motion compensation for deriving the third reference block may be performed by an integer-pixel unit.

Another embodiment of the present invention provides a video decoding apparatus supporting a plurality of layers, the video decoding apparatus including an entropy decoding module to decode information on a first-layer picture to which a second-layer picture as a decoding target refers; and a prediction module to generate information on a base inter-layer reference picture using the information on the first-layer picture, to generate information on an enhanced inter-layer reference picture using the information on the first-layer picture, the information on the base inter-layer reference picture and information on the second-layer picture, and to generate a reference picture list used for inter prediction of the second-layer picture using the information on the base inter-layer reference picture, the information on the enhanced inter-layer reference picture and the information on the second-layer picture.

### Advantageous Effects

According to an embodiment of the present invention, there are provided a video decoding method capable of reducing complexity of an encoder and a decoder by performing integer pixel-based motion compensation in generating an enhanced inter-layer reference picture, and an apparatus using the same.

Also, there are provided a video decoding method capable of enhancing decoding efficiency by applying a weighting based on an encoding parameter and thus omitting transmission of weighting information, and an apparatus using the same.

In addition, there are provided a video decoding method capable of enhancing precision of lower-layer information available as a prediction signal in encoding and decoding a video in an upper layer when encoding and decoding a video based on a multi-layer structure, and an apparatus using the same.

### DESCRIPTION OF DRAWINGS

FIG. 1 is a block diagram illustrating a configuration of a video encoding apparatus according to an exemplary embodiment.

FIG. 2 is a block diagram illustrating a configuration of a video decoding apparatus according to an exemplary embodiment.

FIG. 3 is a conceptual diagram schematically illustrating a scalable video coding structure using a plurality of layers according to an exemplary embodiment of the present invention.

FIG. 4 is a flowchart illustrating a video decoding method according to an exemplary embodiment of the present invention.

FIG. 5 illustrates an enhanced inter-layer reference picture according to an exemplary embodiment of the present invention.

FIG. 6 illustrates generation of an enhanced inter-layer reference picture according to another exemplary embodiment of the present invention.

FIG. 7 schematically illustrates generation of an enhanced inter-layer reference picture according to still another exemplary embodiment of the present invention.

### MODE FOR INVENTION

Hereinafter, embodiments of the present invention are described in detail with reference to the accompanying drawings. In describing the embodiments of the present invention, a detailed description of related known elements or functions will be omitted if it is deemed to make the gist of the present invention unnecessarily vague.

It will be understood that when an element is referred to as being “connected” or “coupled” to another element, the element can be directly connected or coupled to another element or intervening elements. Also, when it is said that a specific element is “included,” it may mean that elements other than the specific element are not excluded and that additional elements may be included in the embodiments of the present invention or the scope of the technical spirit of the present invention.

Although the terms “first,” “second,” etc. may be used to describe various elements, these elements should not be limited by these terms. These terms are used only to distinguish one element from another element. For example, a first element may be named a second element without departing from the scope of the present invention. Likewise, a second element may be named a first element.

Although components described in the embodiments of the present invention are independently illustrated in order to show different characteristic functions, such a configuration does not indicate that each component is constructed by a separate hardware constituent unit or software constituent unit. That is, each component includes individual components that are arranged for convenience of description, in which at least two components may be combined into a single component or a single component may be divided into a plurality of components to perform functions. It is to be noted that embodiments in which some components are integrated into one combined component and/or a component is divided into multiple separate components are included in the scope of the present invention without departing from the essence of the present invention.

Some constituent elements are not essential to perform the substantial functions in the invention and may be optional constituent elements for merely improving performance. The present invention may be embodied by including only constituent elements essential to implement the spirit of the invention other than constituent elements used for merely improving performance. A structure including only the essential constituent elements other than optional constituents used for merely improving performance also belongs to the scope of the present invention.

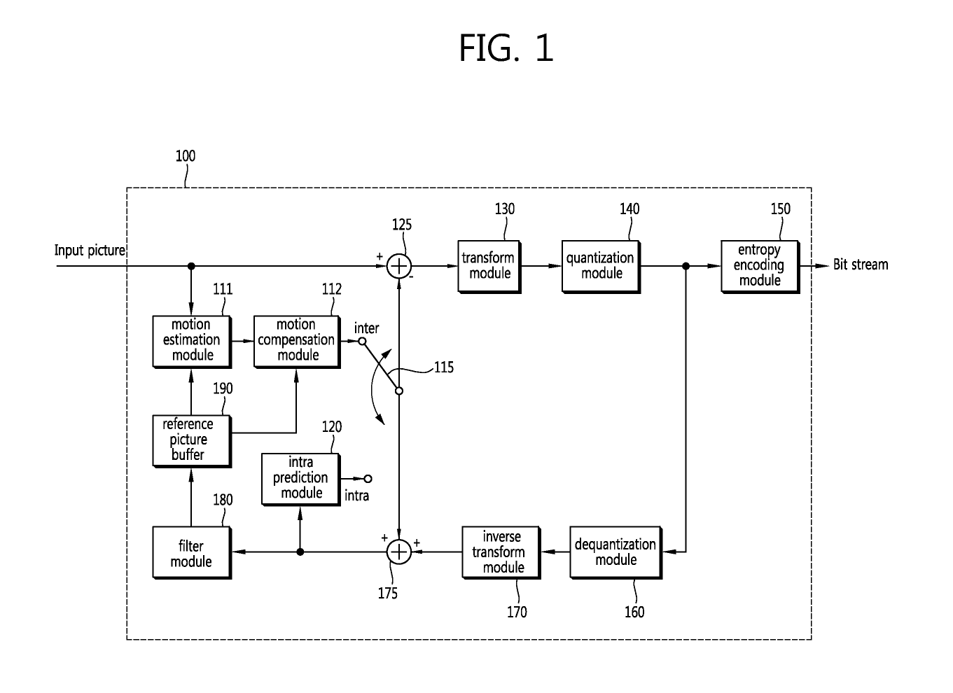

FIG. 1 is a block diagram illustrating a configuration of a video encoding apparatus according to an exemplary embodiment. A scalable video encoding/decoding method or apparatus may be realized by extension of a general video encoding/decoding method or apparatus that does not provide scalability, and the block diagram of FIG. 1 illustrates an example of a video encoding apparatus which may form a basis of a scalable video encoding apparatus.

Referring to FIG. 1, the video encoding apparatus 100 includes a motion estimation module 111, a motion compensation module 112, an intra prediction module 120, a switch 115, a subtractor 125, a transform module 130, a quantization module 140, an entropy encoding module 150, an dequantization module 160, an inverse transform module 170, an adder 175, a filter module 180, and a reference picture buffer 190.

The video encoding apparatus 100 may encode an input picture images in an intra mode or an inter mode and output a bit stream. Intra prediction means an intra-picture prediction, and inter prediction means an inter-picture prediction. In the intra mode, the switch 115 is shifted to ‘intra,’ and in the inter mode, the switch 115 is shifted to ‘inter.’ The video encoding apparatus 100 may generate a prediction block for an input block of the input picture and then encode a difference between the input block and the prediction block.

In the intra mode, the intra prediction module 120 may perform a spatial prediction by using a pixel value of a pre-encoded block around a current block to generate a prediction block.

In the inter mode, the motion estimation module 111 may obtain a region which is most matched with the input block in the reference picture stored in the reference picture buffer 190 during a motion estimation process to derive a motion vector. The motion compensation module 112 may perform motion compensation using the motion vector and the reference picture stored in the reference picture buffer 190, thereby generating the prediction block.

The subtractor 125 may generate a residual block based on the difference between the input block and the generated prediction block. The transform module 130 may transform the residual block to output a transform coefficient. The quantization module 140 may quantize the transform coefficient according to a quantization parameter to output a quantized coefficient.

The entropy encoding module 150 may entropy-encode a symbol according to probability distribution based on values derived by the quantization module 140 or an encoding parameter value derived in encoding, thereby outputting a bit stream. Entropy encoding is a method of receiving symbols having different values and representing the symbols as a decodable binary sequence or string while removing statistical redundancy.

Here, a symbol means a syntax element as an encoding/decoding target, a coding parameter, a value of a residual signal, or the like. A coding parameter, which is a parameter necessary for encoding and decoding, may include information encoded by the encoding apparatus and transferred to the decoding apparatus, such as a syntax element, and information to be inferred during an encoding or decoding process and means information necessary for encoding and decoding a picture. The coding parameter may include, for example, values or statistics of an intra/inter prediction mode, a movement/motion vector, a reference picture index, a coding block pattern, presence and absence of a residual signal, a transform coefficient, a quantized transform coefficient, a block size and block partition information. A residual signal may denote a difference between an original signal and a prediction signal, a transformed signal of the difference between the original signal and the prediction signal, or a transformed and quantized signal of the difference between the original signal and the prediction signal. The residual signal may be referred to as a residual block in a block unit.

When entropy encoding is applied, a symbol having a high probability is allocated a small number of bits and a symbol having a low probability is allocated a large number of bits in representation of symbols, thereby reducing a size of bit strings for symbols to be encoded. Accordingly, entropy encoding may enhance compression performance of video encoding.

For entropy encoding, encoding methods, such as exponential Golomb, context-adaptive variable length coding (CAVLC) and context-adaptive binary arithmetic coding (CABAC), may be used. For example, a table used for performing entropy encoding, such as a variable length coding/code (VLC) table, may be stored in the entropy encoding module 150, and the entropy encoding module 150 may perform entropy encoding using the stored VLC table. In addition, the entropy encoding module 150 may derive a binarization method of a target symbol and a probability model of a target symbol/bin and perform entropy encoding using the derived binarization method or probability model.

The quantized coefficient may be dequantized by the dequantization module 160 and inversely transformed by the inverse transform module 170. The dequantized and inversely transformed coefficient is added to the prediction block by the adder 175, thereby generating a reconstructed block.

The reconstructed block is subjected to the filter module 180, and the filter module 180 may apply at least one of a deblocking filter, a sample adaptive offset (SAO), and an adaptive loop filter (ALF) to the reconstructed block or a reconstructed picture. The reconstructed block obtained via the filter module 180 may be stored in the reference picture buffer 190.

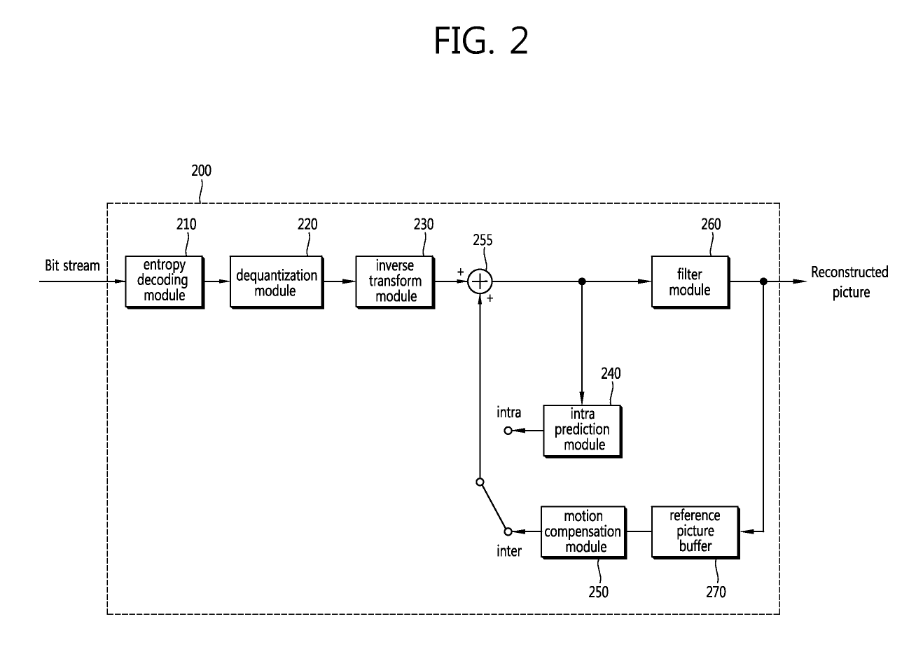

FIG. 2 is a block diagram illustrating a configuration of a video decoding apparatus according to an exemplary embodiment. As described above in FIG. 1, a scalable video encoding/decoding method or apparatus may be realized by extension of a general video encoding/decoding method or apparatus that does not provide scalability, and the block diagram of FIG. 2 illustrates an example of a video decoding apparatus which may form a basis of a scalable video decoding apparatus.

Referring to FIG. 2, the video decoding apparatus 200 includes an entropy-decoding module 210, a dequantization module 220, an inverse transform module 230, an intra prediction module 240, a motion compensation module 250, a filter module 260, and a reference picture buffer 270.

The video decoding apparatus 200 receives an input bit stream output from the encoding apparatus and decodes the bit stream in an intra mode or inter mode to output a reconstituted picture, that is, a reconstructed picture. In the intra mode, a switch may be shifted to ‘intra,’ and in the inter mode, the switch may be shifted to ‘inter. The video decoding apparatus 200 may obtain a residual block reconstructed from the input bit stream, generate a prediction block, and add the residual block and the prediction block to generate a reconstituted block, that is, a reconstructed block.

The entropy decoding module 210 may entropy-decode the input bit stream according to probability distribution to generate symbols including a symbol in a form of a quantized coefficient. Entropy decoding is a method of receiving a binary sequence to generate symbols. The entropy decoding method is similar to the aforementioned entropy encoding method.

The quantized coefficient is dequantized by the dequantization module 220 and inversely transformed by the inverse transform module 230, thereby generating a reconstructed residual block.

In the intra mode, the intra prediction module 240 may perform a spatial prediction by using a pixel value of a pre-encoded block around a current block to generate a prediction block. In the inter mode, the motion compensation module 250 may perform motion compensation using a motion vector and a reference picture stored in the reference picture buffer 270, thereby generating a prediction block.

The reconstructed residual block and the prediction block are added by an adder 255, and the added blocks are subjected to the filter module 260. The filter module 260 may apply at least one of a deblocking filter, an SAO, and an ALF to the reconstructed block or the reconstructed picture. The filter module 260 outputs the reconstituted picture, that is, the reconstructed picture. The reconstructed picture may be stored in the reference picture buffer 270 to be used for inter prediction.

Components directly related to video decoding among the entropy decoding module 210, the dequantization module 220, the inverse transform module 230, the intra prediction module 240, the motion compensation module 250, the filter module 260 and the reference picture buffer 270 included in the video decoding apparatus 200, for example, the entropy decoding module 210, the dequantization module 220, the inverse transform module 230, the intra prediction module 240, the motion compensation module 250 and the filter module 260, may be defined as a decoder or a decoding unit, separately from the other components.

In addition, the video decoding apparatus 200 may further include a parsing module (not shown) to parse information about an encoded video included in the bit stream. The parsing module may include the entropy decoding module 210 or be included in the entropy decoding module 210. The parsing module may be configured as one component of the decoding module.

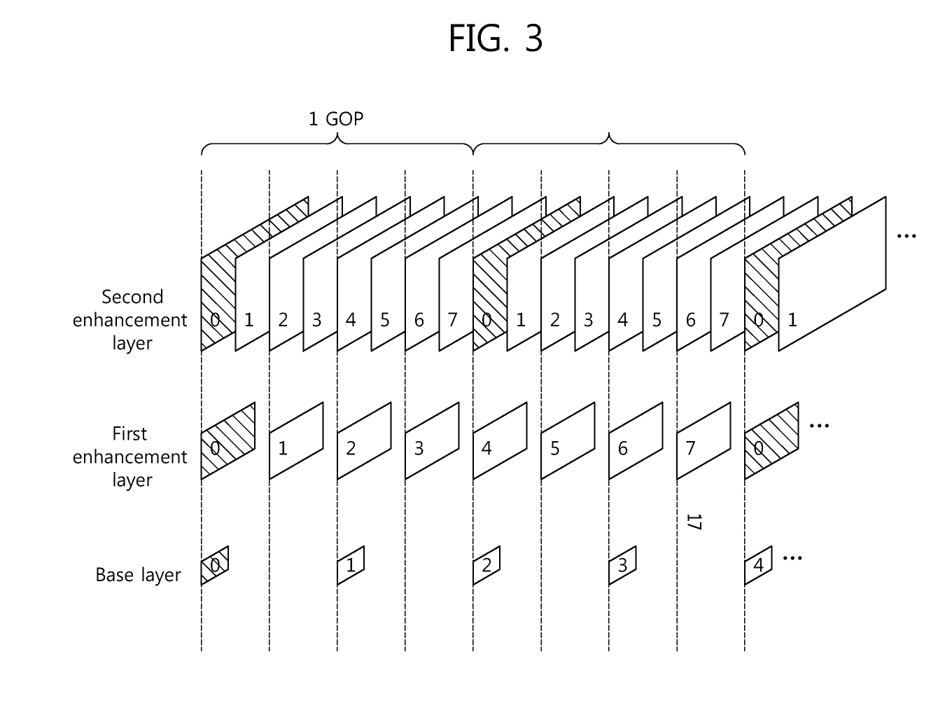

FIG. 3 is a conceptual diagram schematically illustrating a scalable video coding structure using a plurality of layers according to an exemplary embodiment of the present invention. In FIG. 3, Group of Picture (GOP) denotes a picture group, that is, a group of pictures.

In order to transmit video data, a transmission medium is needed, and performance thereof is different by each transmission medium according to various network environments. For application to various transmission media or network environments, a scalable video coding method may be provided.

The scalable video coding method is a coding method which utilizes texture information, motion information, residual signals between layers, or the like to remove redundancy between layers, thus improving encoding/decoding performance. The scalable video coding method may provide scalability in various spatial, temporal, and quality aspects according to ambient conditions such as a transmission bit rate, a transmission error rate, and a system resource.

Scalable video coding may be performed by using a multi-layer structure so as to provide a bit stream applicable to various network situations. For example, the scalable video coding structure may include a base layer in which video data is compressed and processed using a general video encoding method, and also include an enhancement layer in which video data is compressed and processed using both coding information of the base layer and a general video encoding method.

Here, a layer refers to a set of pictures and bit streams that are classified according to a spatial aspect (for example, picture size), a temporal aspect (for example, encoding order, picture output order, and frame rate), picture quality, complexity, or the like. Further, the base layer may mean a lower layer or a reference layer, and the enhancement layer may mean an upper or higher layer. A plurality of layers may have dependency on each other.

Referring to FIG. 3, for example, the base layer may be defined by standard definition (SD), 15 Hz frame rate, and 1 Mbps bit rate, a first enhancement layer may be defined by high definition (HD), 30 Hz frame rate, and 3.9 Mbps bit rate, and a second enhancement layer may be defined by 4K-ultra high definition (UHD), 60 Hz frame rate, and 27.2 Mbps. These formats, frame rates and bit rates are provided only for illustrative purposes and may be changed and modified as needed. Also, a number of used layers may change depending on circumstances, without being limited to the present embodiment.

For instance, when a transmission bandwidth is 4 Mbps, the first enhancement layer HD may be transmitted at a frame rate reduced to 15 Hz or lower. The scalable video coding method may provide spatial, temporal, and quality scalabilities using the method described above with reference to FIG. 3.

Scalable video coding refers to scalable video encoding in encoding, and to scalable video decoding in a decoding.

The present invention relates to a process of encoding/decoding a video including a plurality of layers or views, wherein the plurality of layers or views may be expressed as first, second, third and n-th layers or views. Although the following description will be made with reference to a picture including a first layer and a second layer, the same process may be applied to pictures including two or more layers or views. The first layer may be represented as a base layer, and the second layer as an upper layer. Further, the first layer may be also represented as a reference layer, and the second layer as an enhancement layer.

A picture/block in the first layer (hereinafter, also referred to as “first-layer picture/block,” the same rule applied throughout) corresponding to a second-layer picture/block may be adjusted to a size of the second-layer picture/block. That is, if a size of the first-layer picture/block is smaller than the size of the second-layer picture/block, the first-layer picture/block may be scaled using up-sampling or re-sampling.

The first-layer picture may be added to a reference picture list for the second layer and used for encoding/decoding a second-layer video. Here, the second layer may be subjected to prediction and encoding/decoding using the first-layer picture in the reference picture list, as in general inter prediction.

A block for encoding/decoding may have a square shape with an N×N size, for example, 4×4, 8×8, 16×16, 32×32 and 64×64, or a rectangular shape with an N×M size, for example, 4×8, 16×8 and 8×32, and a block unit may be at least one of a coding block (CB), a prediction block (PB) and a transform block (TB), which may have different sizes.

Hereinafter, a method of generating a prediction block, that is, a prediction signal, of an encoding/decoding target block (“current block” or “target block”) in an upper layer will be described in a method of encoding and decoding a scalable video, that is, a video using a multi-layer structure. The following method or apparatus may be generally applied to both an encoding apparatus and a decoding apparatus.

The prediction signal of the target block may be generated by inter prediction.

In inter prediction, prediction of the current block may be performed based on a reference picture, which is at least one of previous and subsequent pictures of a current picture. A picture used for prediction of the current block is referred to as a reference picture or reference frame.

A region in the reference picture may be specified using a reference picture index refIdx indicating the reference picture and a motion vector.

In inter prediction, the prediction block for the current block may be generated by selecting the reference picture and a reference block in the reference picture corresponding to the current block.

In inter prediction, the encoding apparatus and the decoding apparatus may derive motion information on the current block and perform inter prediction and/or motion compensation based on the derived motion information. Here, the encoding apparatus and the decoding apparatus use motion information on a reconstructed neighboring block and/or a collocated block in an already reconstructed collocated picture corresponding to the current block, thereby improving encoding/decoding efficiency.

Here, the reconstructed neighboring block, which is a block in the current picture reconstructed via encoding and/or decoding, may include a block adjacent to the current block and/or a block positioned on an outer corner of the current block. Further, the encoding apparatus and the decoding apparatus may determine a predetermined relative position based on a block present at a position spatially corresponding to the current block within the collocated picture and derive the collocated block based on the predetermined relative position (internal and/or external position of the block present at the position spatially corresponding to the current block). For instance, the collocated picture may be one picture among reference pictures included in the reference picture list.

In inter prediction, the prediction block with a minimum residual signal from the current block and a minimum-size motion vector may be generated.

Meanwhile, methods of deriving motion information may vary according to a prediction mode of the current block. An advanced motion vector predictor (AMVP) mode, a merge mode, or the like may be used as a prediction mode for inter prediction.

For example, when the AMVP mode is employed, the encoding apparatus and the decoding apparatus may generate a prediction motion vector candidate list by using a motion vector of the reconstructed neighboring block and/or a motion vector of the collocated block. That is, the motion vector of the reconstructed neighboring block and/or the motion vector of the collocated block may be used as a prediction motion vector candidate. The encoding apparatus may transmit a prediction motion vector index indicating an optimal prediction motion vector selected among the prediction motion vector candidates included in the list to the decoding apparatus. In this case, the decoding apparatus may select a prediction motion vector of the current block, using the prediction motion vector index, among the prediction motion vector candidates included in the prediction motion vector candidate list.

The encoding apparatus may calculate a motion vector difference (MVD) between a motion vector of the current block and the prediction motion vector, encode the MVD and transmit the MVD to the decoding apparatus. Here, the decoding apparatus may decode the received MVD and adds the MVD to the prediction motion vector to obtain the motion vector of the current block.

The encoding apparatus may also transmit the reference picture index indicating the reference picture to the decoding apparatus.

The decoding apparatus may predict the motion vector of the current block using motion information on neighboring blocks and derive the motion vector of the current block using a residual received from the encoding apparatus.

The decoding apparatus may receive information indicating which neighboring block used motion information is about, a difference between the motion vector of the current block and the prediction motion vector, and the reference picture index indicating the reference picture from the encoding apparatus.

The decoding apparatus may generate the prediction block for the current block based on the derived motion vector and information of the reference picture index received from the encoding apparatus.

Alternatively, when the merge mode is employed, the encoding apparatus and the decoding apparatus may be generate a merge candidate list using motion information on the reconstructed neighboring block and/or motion information on the collocated block. That is, when the motion information on the reconstructed neighboring block and/or on the collocated block is present, the encoding apparatus and the decoding apparatus may use the motion information as a merge candidate for the current block.

The encoding apparatus may select a merge candidate which provides optimal coding efficiency among merge candidates included in the merge candidate list as motion information for the current block. In this case, a merge index indicating the selected merge candidate may be included in a bit stream to be transmitted to the decoding apparatus. The decoding apparatus may select one of the merge candidates included in the merge candidate list using the transmitted merge index and determine the selected merge candidate as the motion information for the current block. Thus, when the merge mode is employed, the motion information on the reconstructed neighboring block and/or on the collocated block may be used as the motion information for the current block as it is. The decoding apparatus may reconstruct the current block by adding the prediction block to the residual transmitted from the encoding apparatus.

In the aforementioned AMVP and merge modes, the motion information on the reconstructed neighboring block and/or motion information on collocated block may be used in order to derive the motion information on the current block.

In a skip mode as another mode used for inter prediction, information on a neighboring block may be used for the current block as it is. Accordingly, in the skip mode, the encoding apparatus does not transmit syntax information, such as residual, to the decoding apparatus, except for information indicating which block motion information to be used is about as the motion information on the current block.

The encoding apparatus and the decoding apparatus may perform motion compensation on the current block based on the derived motion information, thereby generating the prediction block of the current block. Here, the prediction block may refer to a motion-compensated block generated by performing motion compensation on the current block. Further, a plurality of motion-compensated blocks may form one motion-compensated picture.

The decoding apparatus may verify a skip flag, a merge flag, or the like received from the encoding apparatus and derive motion information needed for inter prediction, for example, information on a motion vector and a reference picture index, accordingly.

A processing unit for performing prediction may be different from a processing unit for determining a prediction method and details on the prediction method. For example, a prediction mode may be determined by each PU while prediction may be performed by each TU. Aldo, a prediction mode may be determined by each PU while intra prediction may be performed by each TU.

For convenience of description, terms relating to a picture used herein are defined as follows.

A current encoding/decoding target picture in a second layer may be referred to as an enhancement picture (EP), and a picture in a first layer corresponding to the encoding/decoding target picture may be referred to as a base picture (BP). The first layer may include any reference layer to which a layer including an encoding/decoding target picture refers, without being limited to a base layer.

An inter-layer reference picture obtained by re-sampling the picture in the first layer may be referred to as an inter-layer picture (ILP), in which if the picture in the first layer and the picture in the second layer have the same size, the ILP may be the same as the BP.

An enhanced inter-layer reference picture generated using first-layer picture information and second-layer picture information may be referred to as an enhanced inter-layer picture (EILP).

A reconstructed temporal reference picture of the current encoding/decoding target picture in the second layer may be represented as an EP′, and a reconstructed picture in the first layer corresponding to the reconstructed temporal reference picture in the second layer may be represented as a BP′. In this specification, a temporal reference picture may mean a temporal reference picture used for inter prediction and refer to a reference picture belonging to the same layer, separately from the inter-layer reference picture.

Similarly to an ILP, an inter-layer reference picture obtained by up-sampling the BP′ may be referred to as an ILP′, in which if the pictures in the first layer and the second layer have the same size, the ILP′ may be the same as the BP′.

Regarding a video supporting a plurality of layers, a prediction signal of a target block in an upper layer may be generated using a reconstructed picture in a lower layer, that is, a reference layer, to which the target block refers, in addition to the foregoing inter prediction method.

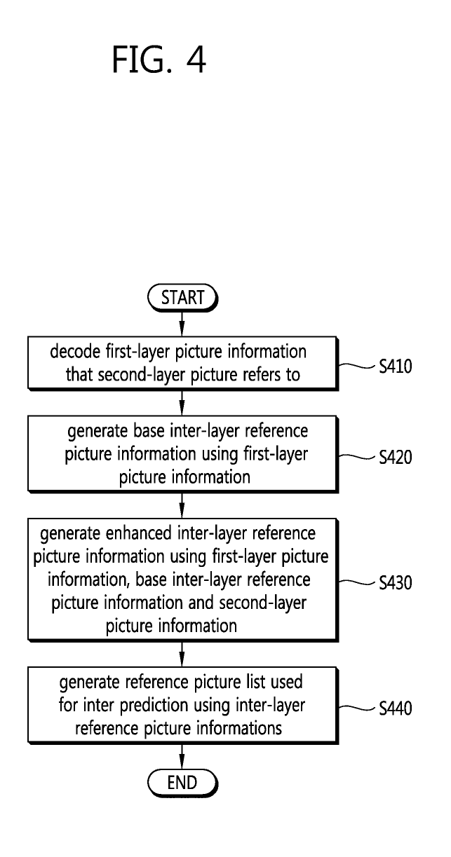

FIG. 4 is a flowchart illustrating a video decoding method according to an exemplary embodiment of the present invention. In detail, FIG. 4 shows a method of encoding and decoding a multi-layer video using information on a picture in a first layer when encoding and decoding a picture in a second layer in a process of encoding and decoding a multi-layer video. Thus, a description of FIG. 4 may be applied to both a video encoding method and a video decoding method. For convenience of description, the following description is made on a decoding process.

First, the decoding apparatus decodes the information on the first-layer picture that the second-layer picture refers to (S410).

The decoding apparatus may decode the encoded information on the first-layer picture corresponding to a second-layer decoding target block to be used as reference information for predicting the target block.

The reference information may include a decoded sample value of the first-layer picture or motion information on the first-layer picture.

The motion information on the first-layer picture may include a motion vector value, a reference picture index, a prediction direction indicator, a reference picture POC, a predation mode, a reference picture list, a merge flag, a merge index, picture type information on a reference picture (whether the reference picture is a short-term reference picture or long-term reference picture), or the like.

The decoded motion information on the first-layer picture may be compressed and stored by an N×N (for example, 16×16) unit.

When the information on the first-layer picture is generated, the decoding apparatus may generate information on a base ILP using the decoded information on the first-layer picture (S420).

The base ILP may include a picture obtained by mapping a size of the first-layer picture on a size of the second-layer picture and a picture obtained by mapping a size of a decoded temporal reference picture of the first-layer picture corresponding to the second-layer picture on a size of a temporal reference picture of the second-layer picture.

When the pictures in the respective layers have different sizes, sample values of the first-layer picture may be subjected to up-sampling so as to map the size of the first-layer picture on the size of the second-layer picture.

For example, if the decoded first-layer picture has a 960×540 size and the second-layer picture has a 1920×1080 size, the first-layer picture may be up-sampled into a second-layer picture size of 1920×1080. The up-sampled picture may be used as the base ILP.

Meanwhile, when the pictures in the respective layers have the same size, the decoded first-layer picture may be used as the base ILP.

In another embodiment, when the pictures in the respective layers have the same size, a picture obtained by filtering the decoded first-layer picture may be used as the base ILP.

For example, a picture obtained by applying a filter with filter coefficients [−1, 3, 12, 3, −1] to the decoded first-layer picture may be used as the base ILP.

When the pictures in the respective layers have different sizes, a base ILP obtained by up-sampling sample values of the first-layer picture may be filtered for use.

In still another embodiment, when the pictures in the respective layers have different sizes, the motion information on the first-layer picture is mapped on the size of the second-layer picture to be used as motion information on the base ILP.

For example, the base ILP is partitioned into N×N units, and motion information corresponding to a position within the first-layer picture corresponding to specific coordinates within the partitioned N×N blocks may be mapped on motion information on a block in the base ILP. Here, ratios in width and length between the pictures in the layers may be reflected in mapping the motion information.

However, when the pictures in the layers have the same size, the decoded motion information on the first-layer picture may be used as motion information on the base ILP.

When the decoded information on the first-layer picture and the information on the base ILP are generated, the decoding apparatus may generate information on an EILP using the decoded information on the first-layer picture, the information on the base ILP and information on the second-layer picture (S430). In the following embodiments, a width and length of a picture in one layer are defined as being twice larger than those of a picture in another layer, respectively, for convenience.

To generate the EILP, the decoded information on the first-layer picture and the decoded information on the second-layer picture may be used in addition to the information on the base ILP generated in S420.

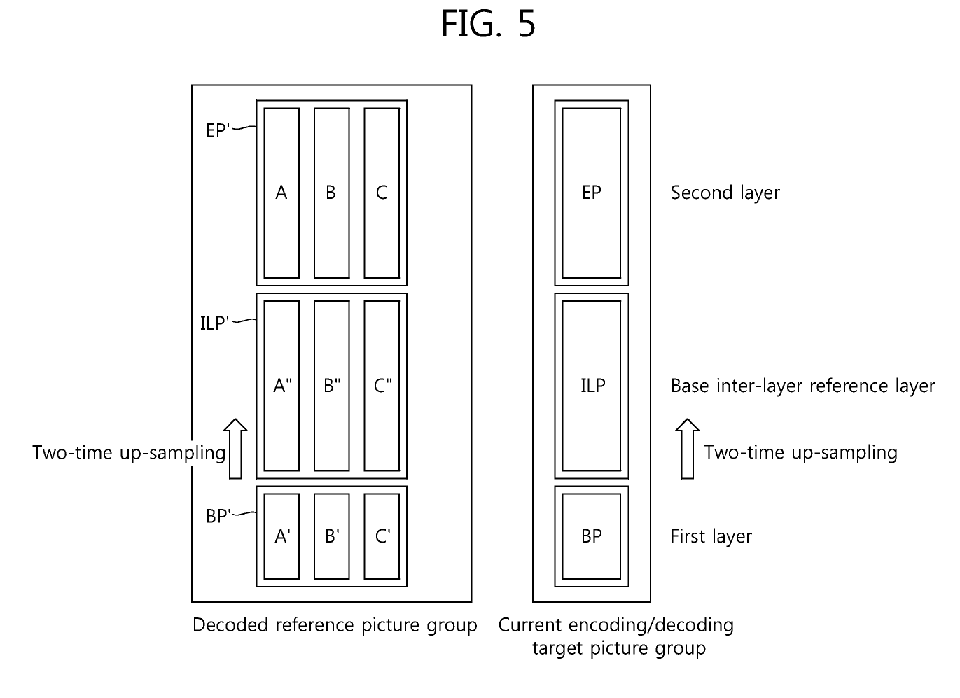

FIG. 5 illustrates an EILP according to an exemplary embodiment of the present invention.

Referring to FIG. 5, a plurality of pictures A, B and C may form a reference picture group EP′ for inter prediction of a second-layer picture EP. That is, for inter prediction of the second-layer picture EP, decoded reference pictures A, B and C may be stored in a memory, such as a decoded picture buffer (DPB), and included in a reference picture list.

Decoded temporal reference pictures A′, B′ and C′ of a first-layer picture BP corresponding to a target picture EP may also form a reference picture group BP′ for the first-layer picture BP.

Base ILPs, A″, B″ and C″ obtained by up-sampling the decoded temporal reference pictures BP′ of the first-layer picture BP may form a base inter-layer reference pictures group ILP′.

An EILP for the second-layer encoding/decoding target picture EP may be generated using the decoded temporal reference pictures EP′ of the second-layer encoding/decoding target picture EP, the decoded temporal reference pictures BP′ of the first-layer picture BP corresponding to the target picture EP and the base inter-layer reference pictures group ILP′ obtained by up-sampling the temporal reference pictures BP′.

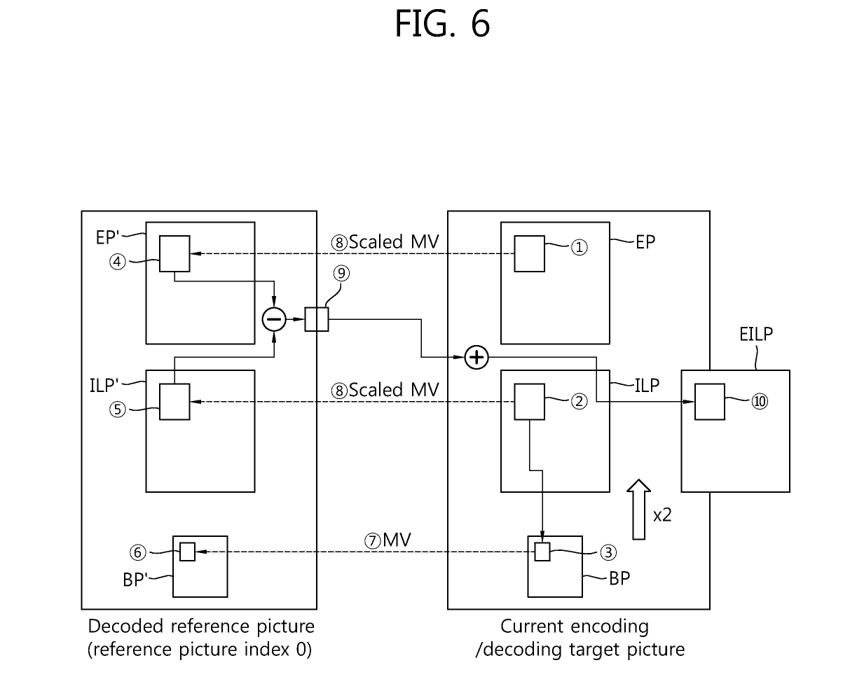

FIG. 6 illustrates generation of an EILP according to another exemplary embodiment of the present invention.

As shown in FIG. 6, an EILP is generated for prediction of an encoding/decoding target block \hat{1} of a second-layer encoding/decoding target picture EP.

To this end, motion information (motion vector and reference picture index) on a first-layer picture BP corresponding to the second-layer target picture EP and a base ILP corresponding to the second-layer encoding/decoding target picture EP may be used.

Widths and lengths of base ILPs including ILP and ILP′ are two times larger than those of the first-layer picture BP and a temporal reference picture BP′ of the first-layer picture.

A block of the first-layer picture BP corresponding in position to the target block of the second-layer target picture EP, for example, an N×N block \hat{1}, is \hat{3}, and a block of the base inter-layer reference picture ILP corresponding in position to the N×N block \hat{1} is \hat{2}. The target block \hat{1} and the block \hat{2} of the base inter-layer reference picture ILP are equivalent in position. The block \hat{2} is an inter-layer corresponding block to the target block \hat{1}, and the block \hat{3} is a corresponding block to the target block \hat{1}.

A reference block in the temporal reference picture BP′ of the first-layer picture BP subjected to motion compensation with respect to the block \hat{3} is \hat{6}, and a motion vector for motion compensation may be defined as a motion vector (MV) \hat{7}.

A reference block in a temporal reference picture EP′ of the second-layer picture EP subjected to motion compensation with respect to the block \hat{1} is \hat{4}, and a reference block in the base inter-layer reference picture ILP′, generated by up-sampling the temporal reference picture BP′ of the first-layer picture BP, subjected to motion compensation with respect to the block \hat{2} is \hat{5}. The blocks \hat{4} and \hat{5} obtained via motion compensation may be used for generating a prediction signal for the N×N block \hat{2}.

As shown in FIG. 6, a motion vector used for motion compensation on the target block \hat{1} and motion compensation on the block \hat{2} of the base inter-layer reference picture ILP′ is a vector \hat{8} Scaled MV obtained by scaling the motion vector \hat{7} in a position of the first-layer block \hat{3} in consideration of ratios in width and length between the pictures in the layers.

In the present embodiment, as the widths and lengths of the base ILPs IPL and ILP′ are two times larger than those of the first-layer picture BP and the temporal reference picture BP′ of the first-layer picture, a vector obtained by scaling the motion vector \hat{7} in the position of the first-layer block \hat{3} twice may be used for motion compensation of the N×N block \hat{2}.

The decoding apparatus calculates a differential value between a sample value of the reference block \hat{4} obtained via motion compensation on the temporal reference picture EP′ and a sample value of the reference block \hat{5} obtained via motion compensation on the base inter-layer reference picture ILP′ using the scaled motion vector, thereby generating a differential block \hat{9}.

The differential block \hat{9} is added to a sample value of the N×N block \hat{2} in the base inter-layer reference picture ILP, and a resulting block CD may be used as a new sample value of the N×N block \hat{2}. That is, the block \hat{1}\hat{0} may be used as a prediction block for reconstructing the second-layer picture EP. The EILP including the new prediction block \hat{1}\hat{0} may be included in a reference picture list used for inter prediction of the second-layer picture EP.

According to one embodiment, the decoding apparatus may apply a weighting to the differential block \hat{9} and add the differential block \hat{9} and the sample value of the N×N block \hat{2}.

A weighting may be applied by a picture, slice, block, or the like, and be inferred from an encoding parameter (for example, motion vector and reference picture index). Further, the encoding apparatus may calculate a weighting, encode information on the weighting and transmit the information to the decoding apparatus.

For example, if a reference picture index of the block \hat{3} of the first-layer picture BP is 0, the weighting may be set to 1. If the reference picture index is 1, the weighting may be set to 0.5.

Alternatively, if the reference picture index of the block \hat{3} is 0, the weighting may be set to 1. If the reference picture index is 1, the weighting may be set to 0.

Alternatively, the weighting may be set considering a reference picture list of the block \hat{3}, that is, a prediction direction. If a reference picture direction of the block \hat{3} is List 0, the weighting may be set to 1. If the reference picture direction is List 1, the weighting may be set to 0.5.

A weighting may vary depending on a luma component and a chroma component.

To sum up, as illustrated in FIG. 6, the decoding apparatus may use, as the new sample value of the N×N block \hat{2}, a signal obtained by adding the sample value of the N×N block \hat{2} in the base inter-layer reference picture ILP, obtained by up-sampling the first-layer picture BP corresponding to the second-layer target picture EP, and a differential signal between the reference block \hat{4} of the decoding target block \hat{1} and the reference block \hat{5} of the N×N block \hat{2}.

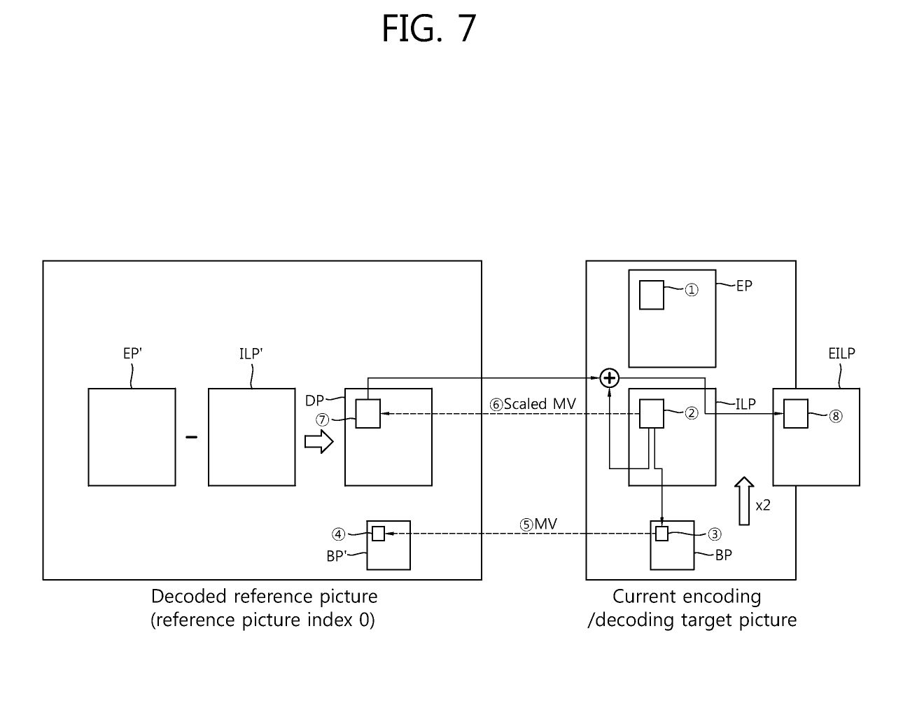

FIG. 7 schematically illustrates generation of an EILP according to still another exemplary embodiment of the present invention. In the present embodiment, a width and length of a picture in one layer may be also twice larger than those of a picture in another layer, respectively.

In the present embodiment, the decoding apparatus may generate a prediction signal for an N×N block \hat{2} using a differential picture DP between a temporal reference picture EP′ of a second-layer encoding/decoding target picture EP and an inter-layer reference picture ILP′ obtained by up-sampling a temporal reference picture of a first-layer picture.

To this end, motion information (motion vector and reference picture index) on the first-layer picture BP corresponding to the second-layer target picture EP and a base ILP corresponding to the second-layer encoding/decoding target picture EP may be used.

A reference block in the temporal reference picture BP′ of the first-layer picture BP obtained by performing motion compensation on a block \hat{3} is \hat{4}, and a motion vector for motion compensation may be defined as a motion vector (MV) \hat{5}.

The decoding apparatus generate the differential picture DP as a difference between the temporal reference picture EP′ of the encoding/decoding target picture EP and the inter-layer reference picture ILP′ obtained by up-sampling the temporal reference picture of the first-layer picture. The decoding apparatus may add a predetermined offset (for example, 128) to the differential picture DP for use.

The decoding apparatus may perform motion compensation on the generated differential DP using motion information on a position of the block \hat{3} in the first-layer picture BP, that is, a scaled motion vector \hat{6} Scaled MV.

In the present embodiment, as the widths and lengths of the base ILPs IPL and ILP′ are two times larger than those of the first-layer picture BP and the temporal reference picture BP′ of the first-layer picture, a vector obtained by scaling the motion vector \hat{5} of the block \hat{3} twice may be used for motion compensation of the N×N block \hat{2}.

The decoding apparatus may add a sample value of a reference block \hat{7}, obtained by motion compensation on the differential picture DP with respect to the N×N block \hat{2}, and a sample value of the N×N block \hat{2}, and a resulting new block \hat{8} may be used as a new sample value of the N×N block \hat{2}. The EILP including the new block \hat{8} may be included in a reference picture list used for inter prediction of the second-layer picture EP.

If an offset is added in generating the differential picture DP, the decoding apparatus may subtract the offset from the sample value of the reference block \hat{7} and then add the sample value of the reference block \hat{7} and the sample value of the N×N block \hat{2}.

Also, the decoding apparatus may apply a weighting to the sample value of the reference block \hat{7} and add the sample value of the reference block \hat{7} and the sample value of the N×N block \hat{2}.

A weighting may be applied by a picture, slice, block, or the like, and be inferred from an encoding parameter (for example, motion vector and reference picture index). Further, the encoding apparatus may calculate a weighting, encode information on the weighting and transmit the information to the decoding apparatus.

For example, if a reference picture index of the block \hat{3} of the first-layer picture BP is 0, the weighting may be set to 1. If the reference picture index is 1, the weighting may be set to 0.5.

Alternatively, if the reference picture index of the block \hat{3} is 0, the weighting may be set to 1. If the reference picture index is 1, the weighting may be set to 0.

Alternatively, the weighting may be set considering a reference picture list of the block \hat{3}, that is, a prediction direction. If a reference picture direction of the block \hat{3} is List 0, the weighting may be set to 1. If the reference picture direction is List 1, the weighting may be set to 0.5.

A weighting may vary depending on a luma component and a chroma component.

To sum up, as illustrated in FIG. 7, the decoding apparatus may use, as the new sample value of the N×N block \hat{2}, the block \hat{8} obtained by adding the N×N block \hat{2} in the base inter-layer reference picture ILP, obtained by up-sampling the first-layer picture BP corresponding to the second-layer target picture EP, and the reference block \hat{7} of the differential picture DP.

According to another embodiment, a motion interpolation filter may be used when performing motion compensation, with respect to the N×N block \hat{2}, on the temporal reference picture EP′ of the second-layer picture, the base inter-layer reference picture ILP′ obtained by up-sampling the first-layer picture or the differential picture DP between the temporal reference picture EP′ of the second-layer picture and the base inter-layer reference picture ILP′.

For example, the decoding apparatus may generate a prediction signal with a sub-pixel precision using a motion interpolation filter, specifically an 8-tap DCT-IF filter for a luma component and a 4-tap DCT-IF filter for a chroma component.

Alternatively, the decoding apparatus may generate a prediction signal with a sub-pixel precision using a bi-linear filter for both a luma component and a chroma component.

For instance, the decoding apparatus may generate a prediction signal with an integer-pixel precision by omitting a sub-pixel based motion compensation process so as to reduce complexity of motion compensation.

To omit the sub-pixel motion compensation process, a mapped motion vector of the N×N block \hat{2}, MV0, may be modified as follows.

In a luma component, the modified motion vector MV0′ may be derived by Equation 1.

MV0′=(MV0+R)& 0xFFFFFFFC, <Equation 1>

Here, if (MV0% 4)<2, R=0; and if (MV0% 4)>=2, R=4.

Alternatively, Equation 2 may be used.

MV0′=(MV0+R)& 0xFFFFFFFC, <Equation 2>

Here, if (MV0% 4)<=2, R=0; and if (MV0% 4)>2, R=4.

Alternatively, R may be always 0 or 4.

Meanwhile, in a chroma component, the modified motion vector MV0′ may be derived by Equation 3.

MV0′=(MV0+R)& 0xFFFFFFF8, <Equation 3>

Here, if (MV0% 8)<4, R=0; and if (MV0% 8)>=4, R=8.

Alternatively, a motion vector MV0′ of a chroma component may be derived by Equation 4.

MV0′=(MV0+R)& 0xFFFFFFF8, <Equation 4>

Here, if (MV0% 8)<=4, R=0; and if (MV0% 8)>4, R=8.

Alternatively, R may be always 0 or 8.

According to still another embodiment, in order to reduce complexity when performing motion compensation on the temporal reference picture EP′ of the second-layer picture, the base inter-layer reference picture ILP′ obtained by up-sampling the first-layer picture or the differential picture DP between the temporal reference picture EP′ of the second-layer picture and the base inter-layer reference picture ILP′ as in the embodiments illustrated with reference to FIGS. 5 to 7, motion compensation may be performed only with respect to an N×N block having a specific reference picture index. That is, the decoding apparatus may perform motion compensation only with respect to an N×N block having a specific reference picture index and add a prediction value (that is, the reference block \hat{9} of FIG. 6 and the reference block \hat{7} of FIG. 7) generated by motion compensation to the N×N block \hat{2}.

For instance, only when a reference picture index of the block \hat{3} of the first-layer picture corresponding to the N×N block \hat{2} of FIG. 6 is 0, motion compensation may be performed on the temporal reference picture EP′ of the second layer and the base inter-layer reference picture ILP′ obtained by up-sampling the first-layer picture with respect to the N×N block \hat{2} and a sample value of the differential block (block \hat{9}) generated by motion compensation may be added to the sample value of the N×N block \hat{2}.

Alternatively, only when a reference picture index of the block \hat{3} of the first-layer picture corresponding to the N×N block \hat{2} of FIG. 7 is 0, motion compensation may be performed on the differential picture DP between the temporal reference picture EP′ of the second layer and the base inter-layer reference picture ILP′ obtained by up-sampling the first-layer picture with respect to the N×N block \hat{2} and a sample value of the differential block (block \hat{7}) generated by motion compensation may be added to the sample value of the N×N block \hat{2}.

According to yet another embodiment, in order to reduce complexity of motion compensation, when performing motion compensation on the temporal reference picture EP′ of the second-layer picture, the base inter-layer reference picture ILP′ obtained by up-sampling the first-layer picture or the differential picture DP between the temporal reference picture EP′ of the second-layer picture and the base inter-layer reference picture ILP′ as in the embodiments illustrated with reference to FIGS. 5 to 7, a sub-pixel motion compensation process may be omitted only for an N×N block having a specific reference picture index, thereby generating a prediction signal with an integer-pixel precision. In this case, Equations 1 to 4 may be applied.

When the information on the EILP is generated in S430, the decoding apparatus may generate a reference picture list used for inter prediction using inter-layer reference picture information (S440). That is, the reference picture list for the second-layer encoding/decoding target picture EP may be generated using the information on the base ILP and the information on the EILP respectively generated in S420 and S430. The reference picture information used for generating the reference picture list may be a POC of a reference picture. The reference picture list may be generated by prediction modules of the decoding apparatus and the encoding apparatus.

When a slice type of a current encoding/decoding target picture is a P slice, the decoding apparatus may add the ILP generated in S420 and the EILP generated in S430 to random positions of a reference picture list 0 List 0. For example, the ILPs may be added to last positions in the reference picture list and changed to different positions using a reference picture list modification syntax.

Alternatively, when the slice type of the current encoding/decoding target picture is a P slice, the decoding apparatus may add selective one of the ILP generated in S420 and the EILP generated in S430 to the reference picture list 0 List 0. The encoding apparatus may encode and transmit, by each slice, information on the selected ILP as information for constructing the reference picture list.

To select one of the IPLs generated in S420 and S430, a sum of absolute differences (SAD) or sum of absolute transformed differences (SATD) between an original picture, that is, the second-layer picture EP, and the ILP obtained in S420 and an SAD or SATD between the second-layer picture EP and the EILP obtained in S430 may be compared. As a result, an ILP having a smaller SAD or SATD may be included in the reference picture list. Alternatively, an ILP may be selected through an SAD or SATD.

Meanwhile, when the slice type of the current encoding/decoding target picture is a B slice, the decoding apparatus may add the ILP generated in S420 and the EILP generated in S430 to random positions of each of the reference picture list 0 List 0 and a reference picture list 1 List 1.

For example, the decoding apparatus may add the ILPs to last positions in the reference picture lists and changed to different positions using a reference picture list modification syntax.

Alternatively, when the slice type of the current encoding/decoding target picture is a B slice, the decoding apparatus may add the ILP generated in S420 to the reference picture list 0 List 0 and add the EILP generated in S430 to the reference picture list 1 List 1.

On the contrary, the decoding apparatus may add the EILP generated in S430 to the reference picture list 0 List 0 and add the ILP generated in S420 to the reference picture list 1 List 1.

In another embodiment, when the slice type of the current encoding/decoding target picture is a B slice, the decoding apparatus may selectively add only one ILP to the reference picture list. The encoding apparatus may encode and transmit, by each slice, information on the selected ILP as information for constructing the reference picture list. The decoding apparatus may construct the reference picture list using the information transmitted from the encoding apparatus.

For example, to select one of the IPLs generated in S420 and S430, an SAD or SATD between an original picture, that is, the second-layer picture EP, and the ILP obtained in S420 and an SAD or SATD between the second-layer picture EP and the EILP obtained in S430 may be compared. As a result, an ILP having a smaller SAD or SATD may be included in a bidirectional reference picture list.

Alternatively, as a result of comparing the SAD or SATD between the second-layer picture EP and the ILP obtained in S420 with the SAD or SATD between the second-layer picture EP and the EILP obtained in S430, if the SAD or SATD between the second-layer picture EP and the EILP is smaller than the SAD or SATD between the second-layer picture EP and the ILP, the decoding apparatus may add the ILP to the reference picture list 0 List 0 and add the EILP to the reference picture list 1 List 1.

A reverse case may be also possible. That is, if the SAD or SATD between the second-layer picture EP and the EILP is smaller than the SAD or SATD between the second-layer picture EP and the ILP, the decoding apparatus may add the EILP to the reference picture list 0 List 0 and add the ILP to the reference picture list 1 List 1.

In another embodiment, as a result of comparing the SAD or SATD between the second-layer picture EP and the ILP obtained in S420 with the SAD or SATD between the second-layer picture EP and the EILP obtained in S430, if the SAD or SATD between the second-layer picture EP and the EILP is greater than the SAD or SATD between the second-layer picture EP and the ILP, the decoding apparatus may add the ILP to the reference picture list 0 List 0 and add the EILP to the reference picture list 1 List 1.

On the contrary, if the SAD or SATD between the second-layer picture EP and the EILP is greater than the SAD or SATD between the second-layer picture EP and the ILP, the decoding apparatus may add the EILP to the reference picture list 0 List 0 and add the ILP to the reference picture list 1 List 1.

The decoding apparatus may apply rate-distortion optimization (RDO) in selecting a reference picture, instead of the SAD or SATD.

The process of constructing the reference picture list illustrated with reference to FIGS. 5 to 7 may be applied not only to the decoding apparatus but also to the encoding apparatus when constructing a reference picture list.

As described above, the present invention provides a video decoding method capable of enhancing precision of lower-layer information available as a prediction signal in encoding and decoding a video in an upper layer when encoding and decoding a video based on a multi-layer structure, and an apparatus using the same.

To this end, when an enhanced inter-layer reference picture is generated, integer pixel-based motion compensation may be performed or a weighting is applied based on an encoding parameter, thereby omitting transmission of weighting information.

In the aforementioned embodiments, methods have been described based on flowcharts as a series of steps or blocks, but the methods are not limited to the order of the steps of the present invention and any step may occur in a step or an order different from or simultaneously as the aforementioned step or order. Further, it can be appreciated by those skilled in the art that steps shown in the flowcharts are not exclusive and other steps may be included or one or more steps do not influence the scope of the present invention and may be deleted.

The foregoing embodiments include various aspects of examples. Although all possible combinations to illustrate various aspects may not described herein, it will be understood by those skilled in the art that various combinations may be made therein without departing from the spirit and scope of the invention as defined by the appended claims. Therefore, all differences, changes and modifications within the scope will be construed as being included in the present invention.

1. A video decoding method supporting a plurality of layers, the video decoding method comprising:
decoding information on a first-layer picture to which a second-layer picture as a decoding target refers;
generating information on a base inter-layer reference picture using the information on the first-layer picture;
generating information on an enhanced inter-layer reference picture using the information on the first-layer picture, the information on the base inter-layer reference picture and information on the second-layer picture; and
generating a reference picture list used for inter prediction of the second-layer picture using the information on the base inter-layer reference picture, the information on the enhanced inter-layer reference picture and the information on the second-layer picture.

2. The video decoding method of claim 1, wherein the generating of the information on the base inter-layer reference picture comprises
generating a first base inter-layer reference picture by mapping a size of the first-layer picture to a size of the second-layer picture; and
generating a second base inter-layer reference picture by mapping a size of decoded temporal reference pictures of the first-layer picture to a size of a temporal reference picture of the second-layer picture.

3. The video decoding method of claim 2, wherein the generating of the information on the enhanced inter-layer reference picture comprises
deriving a first reference block subjected to motion compensation with respect to a target block using a reference picture of the second-layer picture and a motion vector of a block of the first-layer picture corresponding to the target block as a decoding target of the second-layer picture;
deriving a second reference block subjected to motion compensation with respect to an inter-layer corresponding block of the first base inter-layer reference picture corresponding to the target block using the second base inter-layer reference picture and the motion vector;
generating a differential block corresponding to a difference between the first reference block and the second reference block; and
adding the differential block with the inter-layer corresponding block.

4. The video decoding method of claim 3, further comprising applying a weighting to the differential block.

5. The video decoding method of claim 3, further comprising determining whether a reference picture index of a temporal reference picture of the first-layer picture has a preset value,
wherein if the reference picture index has the preset value, motion compensation is performed with respect to the target block and the inter-layer corresponding block using a motion interpolation filter.

6. The video decoding method of claim 3, wherein motion compensation for deriving the first reference block and the second reference block is performed by an integer-pixel unit.

7. The video decoding method of claim 2, wherein the generating of the information on the enhanced inter-layer reference picture comprises
generating a differential picture between a reference picture of the second-layer picture and the second base inter-layer reference picture;
deriving a third reference block subjected to motion compensation with respect to an inter-layer corresponding block of the first base inter-layer reference picture corresponding to a target block using the differential picture and a motion vector of a block of the first-layer picture corresponding to the target block as a decoding target of the second-layer picture; and
adding the third reference block and the inter-layer corresponding block.

8. The video decoding method of claim 7, further comprising applying a weighting to the third reference block.

9. The video decoding method of claim 7, further comprising determining whether a reference picture index of a temporal reference picture of the first-layer picture has a preset value,
wherein if the reference picture index has the preset value, motion compensation is performed with respect to the target block and the inter-layer corresponding block using a motion interpolation filter.

10. The video decoding method of claim 7, wherein motion compensation for deriving the third reference block is performed by an integer-pixel unit.

11. A video decoding apparatus supporting a plurality of layers, the video decoding apparatus comprising:
an entropy decoding module to decode information on a first-layer picture to which a second-layer picture as a decoding target refers; and
a prediction module to generate information on a base inter-layer reference picture using the information on the first-layer picture, to generate information on an enhanced inter-layer reference picture using the information on the first-layer picture, the information on the base inter-layer reference picture and information on the second-layer picture, and to generate a reference picture list used for inter prediction of the second-layer picture using the information on the base inter-layer reference picture, the information on the enhanced inter-layer reference picture and the information on the second-layer picture.

12. The video decoding apparatus of claim 11, wherein the prediction module further generates a first base inter-layer reference picture by mapping a size of the first-layer picture to a size of the second-layer picture, and a second base inter-layer reference picture by mapping a size of decoded temporal reference pictures of the first-layer picture to a size of a temporal reference picture of the second-layer picture.

13. The video decoding apparatus of claim 12, wherein the prediction module derives a first reference block subjected to motion compensation with respect to a target block using a reference picture of the second-layer picture and a motion vector of a block of the first-layer picture corresponding to the target block as a decoding target of the second-layer picture, and a second reference block subjected to motion compensation with respect to an inter-layer corresponding block of the first base inter-layer reference picture corresponding to the target block using the second base inter-layer reference picture and the motion vector, generates a differential block corresponding to a difference between the first reference block and the second reference block, and merges the differential block with the inter-layer corresponding block.

14. The video decoding apparatus of claim 13, wherein the prediction module applies a weighting to the differential block.

15. The video decoding apparatus of claim 13, wherein the prediction module determines whether a reference picture index of a temporal reference picture of the first-layer picture has a preset value, and performs motion compensation with respect to the target block and the inter-layer corresponding block using a motion interpolation filter if the reference picture index has the preset value.

16. The video decoding apparatus of claim 13, wherein the prediction module performs motion compensation by an integer-pixel unit when deriving the first reference block and the second reference block.

17. The video decoding apparatus of claim 12, wherein the prediction module generates a differential picture between a reference picture of the second-layer picture and the second base inter-layer reference picture, derives a third reference block subjected to motion compensation with respect to an inter-layer corresponding block of the first base inter-layer reference picture corresponding to a target block using the differential picture and a motion vector of a block of the first-layer picture corresponding to the target block as a decoding target of the second-layer picture, and merges the third reference block and the inter-layer corresponding block.

18. The video decoding apparatus of claim 17, wherein the prediction module applies a weighting to the third reference block.

19. The video decoding apparatus of claim 17, wherein the prediction module determines whether a reference picture index of a temporal reference picture of the first-layer picture has a preset value, and performs motion compensation with respect to the target block and the inter-layer corresponding block using a motion interpolation filter if the reference picture index has the preset value.

20. The video decoding apparatus of claim 17, wherein the prediction module performs motion compensation by an integer-pixel unit when deriving the third reference block.
